(19) United States
(12) Patent Application Publication
(10) Pub. No.: US 2005/0203448 A1
(43) Pub. Date: Sep. 15, 2005

(54) Handheld massaging device

(76) Inventors: Kenneth David Harris JR., Hollis, NH (US); J. Neil Gleason, Milford, NH (US); Joseph Geringer, Merrimack, NH (US); Steven H. Schwartz, Bedford, NH (US)

Correspondence Address: HAYES, SOLOWAY P.C., 175 CANAL STREET, MANCHESTER, NH, 03101, US

(21) Appl. No.: 10/798,471

(22) Filed: Mar. 11, 2004

(51) Int. Cl. A61H 1/00; A61H 23/02

(52) U.S. Cl. 601/72

(57) ABSTRACT

An apparatus and method for massaging a selected body part is provided. Generally, the apparatus is a handheld massager having a first massage end separated from a second massage end by a handle. Each end of the massager can be independently activated using separate motors. If the user chooses, both ends can be simultaneously activated. With this handheld massager the user can apply massage therapy to any desired body part by guiding the massager with the fingers of the user.

### FIELD OF THE INVENTION

The present invention is generally related to massagers, and more particularly is related to handheld massagers.

### BACKGROUND OF THE INVENTION

Conventional handheld massagers may be grouped into different categories. Two examples of such categories are relatively large models that sometimes require two-handed operation, and more compact models that may be operated with one hand. Massagers in either category may have single or multiple massage heads allowing a user to apply desired massage therapy to a selected body part. Many massage units have a single motor therein that drives one or more actuating elements. The actuating elements may be, for example, vibrational or percussive, thereby providing the massaging action. Other units have shapes designed for massaging specific body parts and may include more than one motor.

The larger “two-handed” massagers tend to be heavier, which may lead to the user becoming fatigued. The smaller handheld massagers typically provide a lower intensity massage due to their typically having the single motor design. In addition, smaller handheld massagers are typically limited in application to a specific body part.

Thus, a heretofore unaddressed need exists in the industry to address the aforementioned deficiencies and inadequacies.

### SUMMARY OF THE INVENTION

Embodiments of the present invention provide an apparatus and method for applying massage therapy to a selected body part of the user. Briefly described, in architecture, one embodiment of the invention, among others, can be implemented as follows. The apparatus has vibrating massage heads at opposing ends of the massage unit. Each massage head is controlled by its own motor. The motors share a common power supply, and either motor can be turned on or off independently. One massage head of the massage unit may be wider than the other massage head. Massage application by either massage head can be controlled by guiding the selected massage head with the fingers of a user.

The present invention can also be viewed as providing methods for applying massage therapy to a selected body part of the user using a massager unit comprising a first massage head separated by an elongate handle from a second massage head. In this regard, one embodiment of such a method, among others, can be broadly summarized by the following steps: pressing a first button, resulting in closing a first switch so that power is provided from a first power source to a first motor; pressing a second button, resulting in closing a second switch so that power is provided from a second power source to a second motor; applying one of the first massage head or the second massage head to a selected body part; and guiding the one of the first massage head or the second massage head using the elongate handle and at least one depression, wherein the at least one depression is located on the massager unit and is shaped to fit a finger thereon.

Other systems, methods, and advantages of the present invention will be or become apparent to one with skill in the art upon examination of the following drawings and detailed description. It is intended that all such additional systems, methods, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a perspective view of the top of the massager unit illustrating the finger depressions in accordance with a first exemplary embodiment of the invention.

FIG. 2 is a perspective view of the bottom of the massager unit illustrating the first massage head and the second massage head in accordance with the first exemplary embodiment of the invention.

FIG. 3 is a cross-sectional view of the massager unit illustrating internal construction of the massager unit, in accordance with the first exemplary embodiment of the invention.

### DETAILED DESCRIPTION

The following is a description of a massager unit having separate massage heads located at opposite ends of a central handle. Each massage head is individually controlled by its own individual motor.

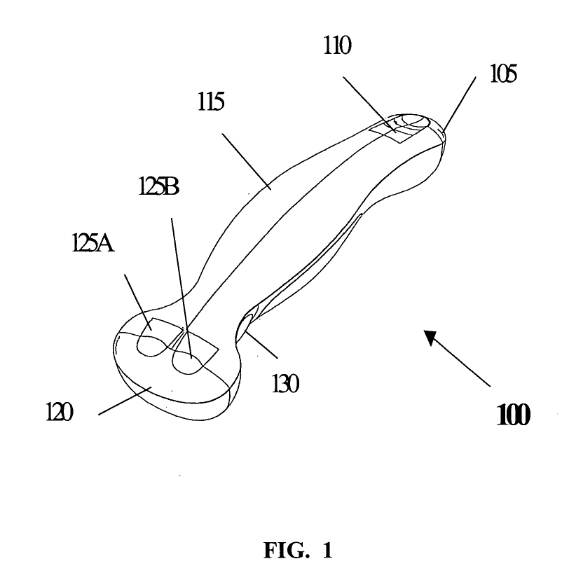

FIG. 1 is a top perspective view of a massager unit 100 in accordance with a first exemplary embodiment of the invention. As is shown by FIG. 1, the massager unit 100 has a first massage head 120 separated from a second massage head 105 by an elongate handle 115. In the first exemplary embodiment of the invention the handle 115 of the massage unit 100 has a convex contour to conform to the shape of the palm of the hand of a user. In alternative embodiments of the invention the handle 115 may have a cylindrical shape or the handle 115 may have a rectangular shape. In fact, the shape of the handle may even vary from the shapes described herein.

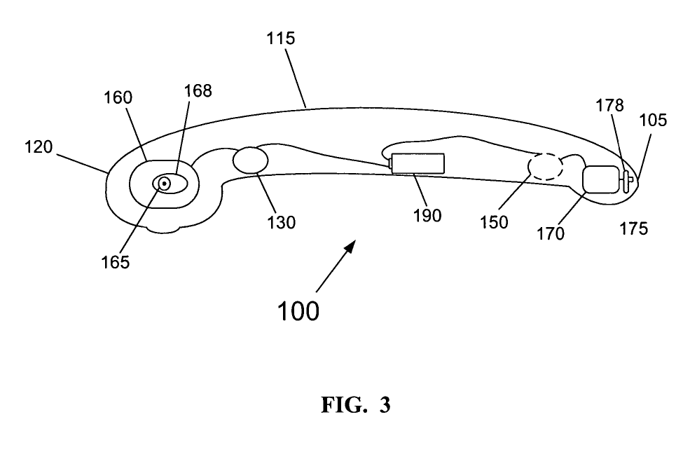

In the first exemplary embodiment of the invention, a first button 130 is located on the handle portion 115 of the massager unit 100, specifically, near the first massage head 120. As will be further described herein, the first button 130 controls a first switch 132 (FIG. 3) that is operatively coupled between at least one battery 190 (FIG. 3) and a first motor 160 (FIG. 3) to provide electrical power to the first motor 160 (FIG. 3) when the first switch 132 is closed. When the massager unit 100 is held in the right hand of the user, the first button 130 and the first switch 132 allow the user to switch the massaging action of the first massage head 120 on and off by using the thumb of the right hand. In alternative embodiments of the invention, the first button 130 may be located on the opposite side of the handle 115 for users preferring to operate the massager unit 100 with the left hand. In addition, the first button 130 may be located on the top portion of the handle 115 or on the bottom portion of the handle 115.

In accordance with the first exemplary embodiment of the invention, the top portion of the first massage head 120 has two first massage head depressions 125A, 125B to allow the user to place two fingers on the first massage head 120 to control massage application and pressure. It should be noted that alternative embodiments of the invention may differ by, for example, including additional depressions or excluding some or all depressions on the top portion of the first massage head 120 of the massage unit 100.

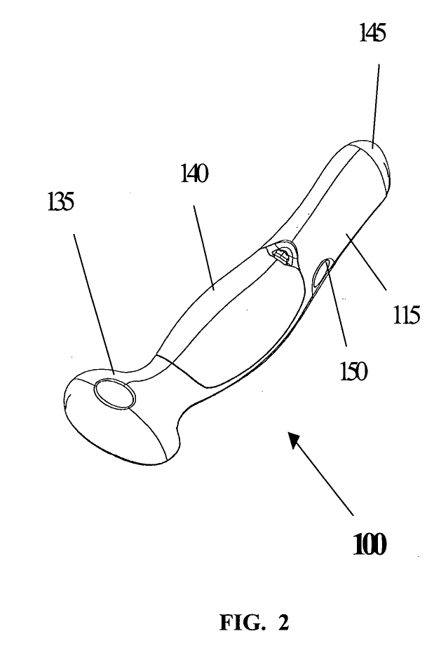

FIG. 2 is a bottom perspective view of a massager unit 100 in accordance with a first exemplary embodiment of the invention. Referring to FIG. 1 and FIG. 2, the first massage head 120 of the massager unit 100 has a first active massage portion 135 to apply massaging action directed by two fingers of the user placed in the first massage head depressions 125A, 125B on the top portion of the first massage head 120. In the first exemplary embodiment of the invention the first active massage portion 135 is a substantially oval shaped dome. Alternative embodiments of the invention may have a first active massage portion 135 of different shape for example, but not limited to, a hemispherical or conical shaped first active massage portion 135. The first active massage portion 135 may also have multiple small features for example, but not limited to, multiple conical shapes or multiple hemispheres. Other embodiments of the invention may have a larger or smaller first active massage portion 135.

On an end opposite the first massage head 120, the substantially convex lower portion 145 of the second massage head 105 is the active massage area. In accordance with the first exemplary embodiment of the invention, massage application from the second massage head 105 is directed by one finger of the user placed in a second massage head depression 110 on the top portion of the second massage head 105. It should be noted that alternative embodiments of the invention may differ by, for example, including additional depressions or excluding some or all depressions on the top portion of the second massage head 115 of the massage unit 100.

In the first exemplary embodiment of the invention, a second button 150 is located on the handle 115 of the massager unit 100, specifically, near the second massage head 105. The second button 150 controls a second switch 152 (FIG. 3) the is operatively coupled between at least one battery 190 (FIG. 3) and a second motor 170 (FIG. 3) to provide electrical power to the second motor 170 (FIG. 3) when the second switch 152 is closed. When the massager unit 100 is held in the right hand of the user, the second button 150 allows the user to switch the massaging action of the second massage head 105 on and off by using the thumb of the right hand. In alternative embodiments of the invention, the second button 150 may be located on the opposite side of the handle 115 for users preferring to operate the massager unit 100 with the left hand. In addition, the second button 150 may be located on the top portion of the handle 115 or the bottom portion of the handle 115.

In the first exemplary embodiment, two separate switches 132, 152 allow the massaging action of the second massage head 105 and the first massage head 120, respectively, to be turned on or off individually or simultaneously. In an alternative embodiment of the invention, a single multiple-selection button, controlling a multiple-selection switch, placed in a predetermined location on the massager unit 100 may be used to control the second massage head 105 and the first massage head 120 individually or simultaneously.

FIG. 3 is a cross-sectional view of the massager unit 100 illustrating internal construction of the massager unit 100. Referring to FIG. 3, the massaging action of the first massage head 120 is provided by, for example, but not limited to, the first motor 160, which is located in close proximity to, and operatively coupled to, the first massage head 120 to transfer vibrations to the first massage head 120. In accordance with the first exemplary embodiment of the invention, the first motor 160 controls a first vibrating element 165 connected thereto. The first vibrating element 165 may be, but is not limited to, a first weight 168 coupled to the shaft of the first motor 160, such that the first weight 168 is offset from an axis of rotation of the shaft of the first motor 160. Activating the first motor 160 with the first switch 132 causes the first motor 160 and the first weight 168 to rotate. The offset placement of the first weight 168 causes vibration as the first weight 168 rotates.

The resulting vibration is transferred to first massage head 120 through mechanical connection to the first motor 160, thereby producing massaging action of first massage head 120. As will be understood by those having ordinary skill in the art, additional components or structures may be employed to provide transfer of vibration from the first motor 160 to the first massage head 120, for example, but not limited to, washers, grommets, housings, or encapsulants. As will also be understood by those having ordinary skill in the art, alternative embodiments of the invention may employ other methods for providing vibrational or percussive elements to provide massaging action at the first massage head 120 of the massage unit 100, for example, but not limited to, pistons, cams, or magnetically coupled devices.

The massaging action of the second massage head 105 is provided by, for example, but not limited to, the second motor 170, which is located in close proximity to, and operatively coupled to, the second massage head 105 to transfer vibrations to the second massage head 105. In accordance with the first exemplary embodiment of the invention, the second motor 170 controls a second vibrating element 175 connected thereto. The second vibrating element 175 may be, but is not limited to, a second weight 178 coupled to the shaft of the second motor 170, such that the second weight 178 is offset from the axis of rotation of the shaft of the second motor 170. Activating the second motor 170 with the second switch 152 causes the second motor 170 and the second weight 178 to rotate. The offset placement of the second weight 178 causes vibration as the second weight 178 rotates.

The resulting vibration is transferred to second massage head 105 through mechanical connection to the second motor 170, thereby producing massaging action of second massage head 105. As will be understood by those having ordinary skill in the art, additional components or structures may be employed to provide transfer of vibration from the second motor 170 to the second massage head 105, for example, but not limited to, washers, grommets, housings, or encapsulants. As will also be understood by those having ordinary skill in the art, alternative embodiments of the invention may employ other methods for providing vibrational or percussive elements to provide massaging action at the second massage head 105 of the massage unit 100, for example, but not limited to, pistons, cams, or magnetically coupled devices.

In the first exemplary embodiment of the massage unit 100, the handle 115 has a covered compartment 140 formed to hold at least one battery 190 operable as a single power supply for both the first motor 160 and the second motor 170. In an alternative embodiment of the invention, power for the first motor 160 and the second motor 170 may be provided by an external power source connected to the massage unit 100 by a cable. The power source may be, for example, but not limited to, an external battery or batteries, or a power source connected to alternating current (AC) residential or commercial utility power.

It should be emphasized that the above-described embodiments of the present invention are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

1. A massager unit, comprising:
an elongate handle having a first end and a second end;
a first massage head disposed at the first end of the handle;
a first motor operatively coupled to the first massage head;
a second massage head disposed at the second end of the handle; and
a second motor operatively coupled to the second massage head.

2. The massager unit of claim 1, further comprising:
a first switch operable to control the first motor; and
a second switch operable to control the second motor.

3. The massager unit of claim 1, further comprising:
at least one first weight coupled to the first motor, wherein the first weight is offset from an axis of rotation of the first motor, thereby causing vibrations as the first weight rotates; and
at least one second weight coupled to the second motor, wherein the second weight is offset from an axis of rotation of the second motor, thereby causing vibrations as the second weight rotates.

4. The massager unit of claim 3, further comprising:
a power supply contained within the elongate handle wherein the power supply is operatively coupled to the first motor and the second motor to provide electrical power to the first motor and the second motor.

5. The massager unit of claim 4, wherein the power supply is at least one battery.

6. The massager unit of claim 5 wherein the handle further comprises a cavity constructed and arranged to retain the at least one battery.

7. The massager unit of claim 1, further comprising a power supply, wherein the power supply is external to the massager unit.

8. The massager unit of claim 7, wherein the power supply means is at least one battery.

9. The massager unit of claim 7, wherein the power supply means is coupled to alternating current (AC) power.

10. The massager unit of claim 1, further comprising:
a switch operable to independently control the first motor and the second motor.

11. The massager unit of claim 1, wherein an active massage area of the first massage end further comprises a substantially oval-shaped dome.

12. The massager unit of claim 1, wherein an active massage area of the first massage end further comprises a plurality of hemispheres.

13. The massager unit of claim 1, wherein an active massage area of the first massage end further comprises a plurality of conical shapes.

14. The massager unit of claim 1, wherein the handle has a substantially convex contour to fit a hand of a user.

15. The massager unit of claim 1, wherein the handle is substantially cylindrical.

16. The massager unit of claim 1, wherein the handle is substantially rectangular.

17. A massager unit, comprising:
an elongate handle having a first end and a second end;
a first massage head disposed at the first end of the handle, wherein the first massage head comprises,
an upper portion having a first massage head depression substantially parallel to the elongate dimension of the handle, whereby the first massage head depression accommodates one finger of a user placed therein, and
a lower portion comprising an active massage area; and
a second massage head disposed at the second end of the handle, wherein the second massage head comprises,
an upper portion having a first, second massage head depression substantially parallel to the elongate dimension of the handle and a second, second massage head depression substantially parallel to the first, second massage head depression, whereby the depressions accommodate two fingers of a user placed therein, and
a lower portion comprising an active massage area whereby the second massage head is wider than the first massage head.

18. A method of providing massage therapy to a selected body part of the user using a massager unit comprising a first massage head separated by an elongate handle from a second massage head, the method comprising the steps of:
pressing a first button, resulting in closing a first switch so that power is provided from a first power source to a first motor;
pressing a second button, resulting in closing a second switch so that power is provided from a second power source to a second motor;
applying one of the first massage head or the second massage head to a selected body part; and
guiding the one of the first massage head or the second massage head using the elongate handle and at least one depression, wherein the at least one depression is located on the massager unit and is shaped to fit a finger thereon.

19. A massager unit, comprising;
an elongate handle having a first end and a second end;
a first massage head disposed at the first end of the handle;
a first means for vibrating operatively coupled to the first massage head;
a second massage head disposed at the second end of the handle; and
a second means for vibrating operatively coupled to the second massage head.

20. The massager unit of claim 19, further comprising:
means for controlling the first means for vibrating; and
means for controlling the second means for vibrating.
